(19) United States
(12) Patent Application Publication
(10) Pub. No.: US 2017/0230565 A1
(43) Pub. Date: Aug. 10, 2017

(54) AUTOMATIC FOLLOW FOCUS SYSTEM

(71) Applicant: Damian Silva, Orlando, FL (US)

(72) Inventor: Damian Silva, Orlando, FL (US)

(21) Appl. No.: 15/017,783

(22) Filed: Feb. 8, 2016

(51) Int. Cl. H04N 5/232

(52) U.S. Cl. CPC H04N 5/23206; H04N 5/23216; H04N 5/23293

(57) ABSTRACT

An automatic follow focus system includes a camera unit having a main body, a circular drive gear for engaging the focus control of a camera lens, an electric motor for operating the circular drive gear, and a rail mounting unit. One or more target beacons are in wireless communication with the camera unit, and a remote operation unit controls an operation of the camera unit. The system includes functionality for determining a separation distance between the camera unit and each target beacon, and automatically operates the motor of the camera unit to adjust the focus control of the camera lens based upon the determined separation distance.

### TECHNICAL FIELD

The present invention relates generally to the field of image capturing devices, and more particularly to a system that automatically focuses a camera lens based on the distance between the camera and a subject.

### BACKGROUND

The statements in this section merely provide background information related to the present disclosure and may not constitute prior art.

One of the key elements of photography is providing a clear and distortion free image. In this regard, high end equipment such as Digital Single Lens Reflect (DSLR) cameras, for example, typically includes a lens focus member that must be adjusted based on the distance between the camera lens and the camera target. To this end, when filming moving objects, the camera operator must make continuous focus adjustments to maintain a clear image of the target at all times.

As shown in background FIG. 1, many cameras 1 are typically mounted onto a camera rail system 2, and often employ some type of follow focus accessory device 3. These follow focus devices generally comprise a rotatable control knob 3a which rotates relative to an index marker and which in turn rotates an output member 3b that meshes with a corresponding focusing ring 1a supported about the lens 1b of the camera for rotation with a rotating component of the lens used for focusing. One example of a follow focus device is described in U.S. Patent Publication No. 2010/0259669, to Wood, the contents of which are incorporated herein by reference.

In this regard, conventional follow focus devices allow an operator to be more efficient and precise when performing actions such as a focus pull, for example. Although useful for this purpose, such devices still rely on the skill and ability of the device operator to judge the distance between the camera lens and the target, and to manually adjust the lens based on that calculation.

Accordingly, it would be beneficial to provide an automatic follow focus system that can automatically adjust the focus of a camera based on the distance with the camera target, thereby eliminating the drawbacks of the above noted devices.

### SUMMARY OF THE INVENTION

The present invention is directed to an automatic follow focus system for attachment onto a camera having a focusing control and a rail system. One embodiment of the present invention can include a camera unit having a main body, a circular drive gear for engaging the focus control of a camera lens, an electric motor for operating the circular drive gear, and a rail mounting unit. The present invention can further include one or more target beacons that are in wireless communication with the camera unit, and a remote operation unit that is in wireless communication with the camera unit and can control an operation of the same.

In another embodiment, the system can function to determine the separation distance between the camera unit and each target beacon. The system can also function to automatically operate the motor of the camera unit to adjust the focus control of the camera lens based upon the determined separation distance.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a follow focus device, in accordance with background art.

FIG. 2 is a perspective view of an automatic follow focus system that is useful for understanding the inventive concepts disclosed herein.

FIG. 3A is a perspective view of the camera unit of the automatic follow focus system, in accordance with one embodiment of the invention.

FIG. 3B is a side view of the camera unit of the automatic follow focus system, in accordance with one embodiment of the invention.

FIG. 4 is a simplified block diagram of the system controller of the camera unit of FIGS. 3A and 3B.

FIG. 5A is a front view of one of the target beacons of the automatic follow focus system, in accordance with one embodiment of the invention.

FIG. 5B is a simplified block diagram of the target beacon of FIG. 5A.

FIG. 6A is a front view of the remote operation unit of the automatic follow focus system, in accordance with one embodiment of the invention.

FIG. 6B is a simplified block diagram of the remote operation unit of FIG. 6A.

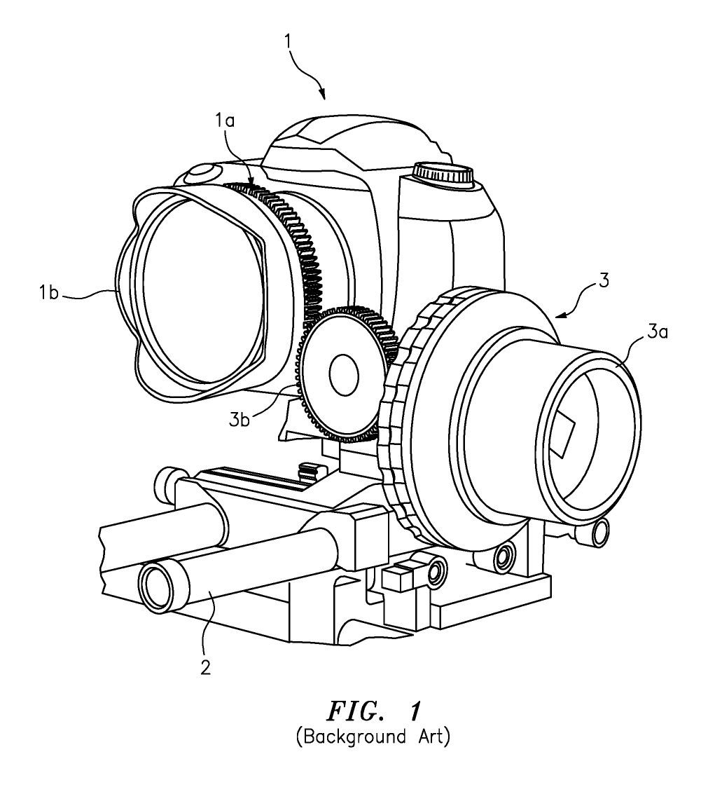

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

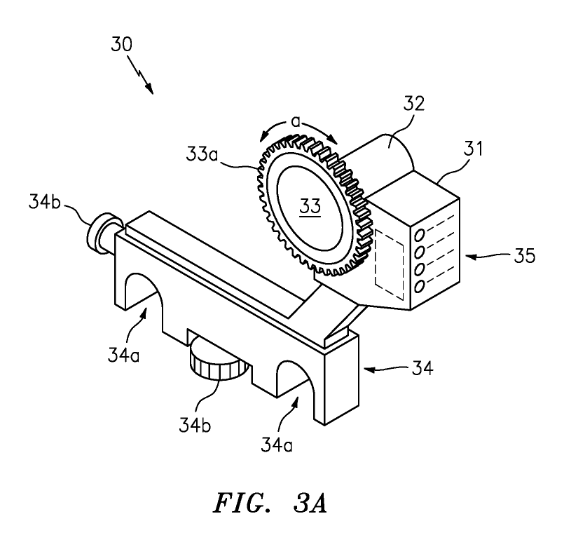

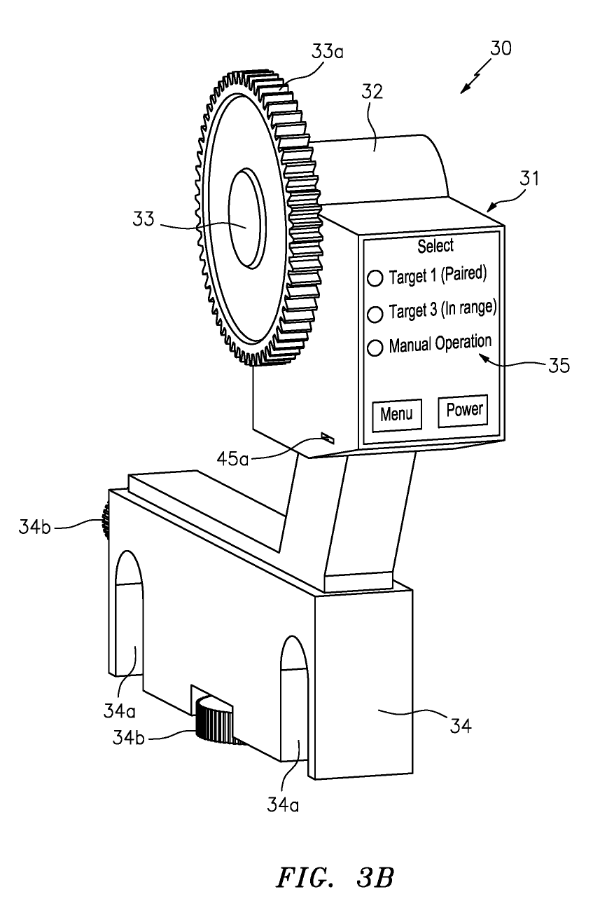

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 3A.

As described throughout this document, the term “target” shall be used to describe a person and/or object that is being filmed by a camera, and to whom a separation distance from the camera is to be determined. As further described herein, the terms “removably secured,” “removably engage,” and derivatives thereof shall be used to describe a situation wherein two or more objects are joined together in a non-permanent manner so as to allow the same objects to be repeatedly joined and separated.

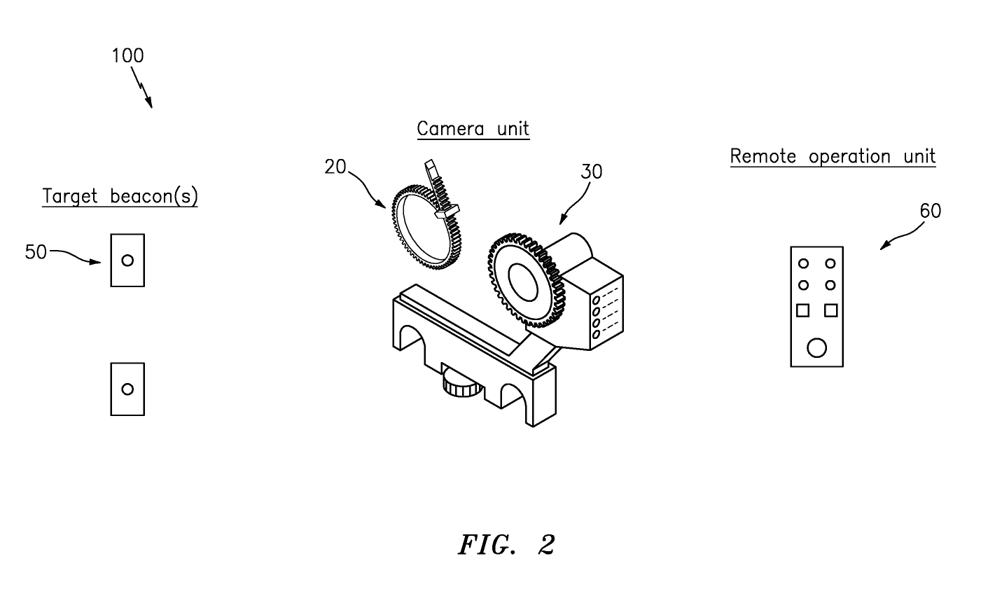

FIG. 2 illustrates one embodiment of an automatic follow focus system 100 that is useful for understanding the inventive concepts described herein. As shown, the system can include, a camera unit 30 that is in communication with one or more target beacons 50 and/or a remote operation unit 60. As will be described below, the camera unit can be mated with any number of different cameras, and can detect the separation distance between the unit 30 and the target beacon. Upon determining the separation distance, the system can automatically adjust the focus of the camera without requiring user intervention. Moreover, the system can allow a device operator to select different targets for automatic focusing by the camera, and/or provide manual control of the camera unit via the remote operation device.

FIGS. 3A and 3B illustrate side and front views of the camera unit 30, in accordance with one embodiment. As shown, the camera unit can include a main body 31, an electric motor 32, a circular drive gear 33, a rail mounting unit 34, a user display unit 35, and an internal device controller 40. As described herein, the body 31 can take any number of distinct shapes, and can be constructed from any number of different materials and construction methodologies. In one preferred embodiment, body 31 can be constructed from injection molded plastic having an internal cavity with a plurality of connectors (not shown) for securely positioning the internal controller 40 in a secure and weather resistant manner.

The motor 32 can be physically coupled to the drive gear 33 and can function to rotate the same, as shown by arrow a. The motor can include any number of electrically driven components, and can receive operating instructions from the controller 40. The drive gear 33 can include a generally circular member having a plurality of ridges 33a disposed along an outside portion thereof. Each of these ridges are arranged so as to mesh with, and engage a focusing ring and/or the focus control of a camera lens.

In various embodiments, the system 100 can also include an adjustable diameter focusing ring 20 having a plurality of ridges 21. The ring can be interposed between the drive gear 33 and the focusing control of a camera, as is known in the art.

The rail mounting unit 34 can include one or more mounting portions 34a that extend downward from the main body. The rail mount unit can function to removably engage one or more camera rails that are provided with virtually all commercially available camera rail systems. In this regard, the rail mount can include adjustment mechanisms 34b which can adjust the dimension(s) of the mounting portions so as to allow the rail mount to be securely connected to the rail system. Although illustrated with respect to a particular shape, this is for illustrative purposes only, as the camera unit can include any number of different shapes and sizes that are designed to align the drive gear 33 with a focusing ring on a camera, and/or to accommodate any type of rail system.

As shown best in FIG. 3B, one embodiment of the camera display unit 35 can include a Graphic User Interface (GUI) screen for providing two way communication with a user. To this end, GUI screen 35 can preferably include a color touch screen monitor for providing a menu of actions that a user can select for instructing the system to perform. The GUI can also function to display additional information such as an operating status of each target beacon 60.

Although described and illustrated with respect to a GUI screen, the display unit 35 is not to be construed as limiting to such a device, as other embodiments are also contemplated. For example, any number of distinct screens, operating lights and/or resilient push buttons, for example, can be provided and arranged so as to perform and display operating information.

FIG. 4 is a simplified block diagram illustrating one embodiment of the camera unit device controller 40. As shown, the device controller can include a processor 41 that is conventionally connected to an internal memory 42, a communication unit 43, a component interface unit 44, and a power unit 45.

Although illustrated as separate elements, those of skill in the art will recognize that one or more system components may be, or include one or more printed circuit boards (PCB) containing an integrated circuit or circuits for completing the activities described herein. The CPU may be one or more integrated circuits having firmware for causing the circuitry to complete the activities described herein. Of course, any number of other components capable of performing the below described functionality can be provided in place of, or in conjunction with the below described controller elements.

The processor/CPU 41 can act to execute program code stored in the memory 42 in order to allow the device to perform the functionality described herein. Processors are extremely well known in the art, therefore no further description will be provided.

Memory 42 can act to store operating instructions in the form of program code for the processor 41 to execute. Although illustrated in FIG. 4 as a single component, memory 42 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device. Additionally, memory 42 can also include one or more cache memories that provide temporary storage of at least some program code in order to reduce the number of times program code must be retrieved from the bulk storage device during execution. Each of these devices are well known in the art.

The communication unit 43 can function to provide wired and/or wireless two way communication between the camera unit, the target beacon 50, the remote operation unit 60 and/or secondary devices such as a computer, smartphone or other processor enabled device, for example. In one preferred embodiment, the communication unit can include a variable radio transmitter and receiver having a unique frequency chip capable of sending and receiving a plurality of independent radio frequencies which are stored in the memory 42. Of course, any number of other known transmission/reception mechanisms and protocols can also be utilized herein, several nonlimiting examples include Bluetooth, infrared (IR), and/or a network adapter functioning to communicate over a WAN, LAN or the internet, for example.

The component interface unit 44 can function to provide a communications link between the processor 41 and each of the other device elements such as the user display 35 and the motor 32, for example. In this regard, the component interface unit can include any number of different components such as one or more PIC microcontrollers, internal bus, USB connections and other such hardware capable of providing a direct link between the various components. Of course any other means for providing the two way communication between the identified components can also be utilized herein.

In one preferred embodiment, the power unit 45 can include one or more DC batteries capable of providing the necessary power requirements to each element of the device 30. In one embodiment, the batteries can be permanently located within the main body and/or can be rechargeable in nature via a charging port 45a, such as a mini or micro USB port, for example. Of course, the power unit can also include a common A/C electrical power transformer and cord capable of allowing the table unit 10 to be powered from a standard electrical outlet.

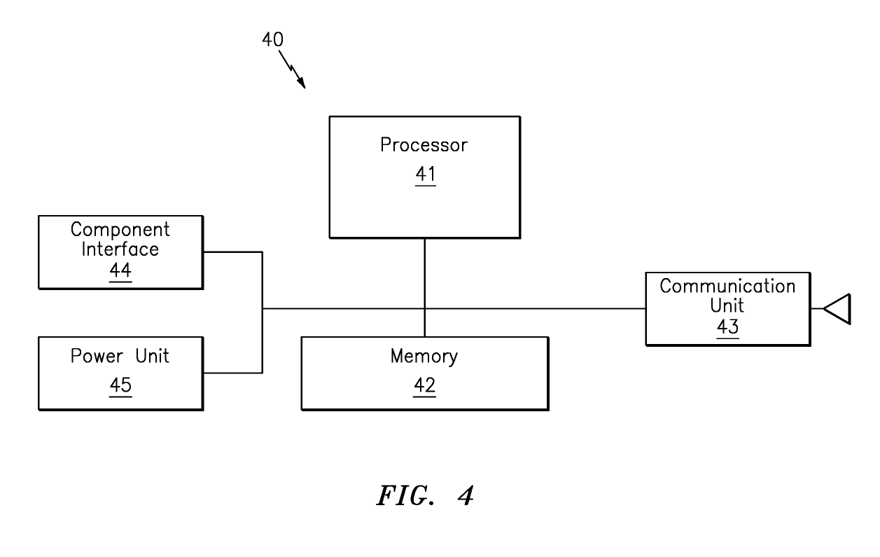

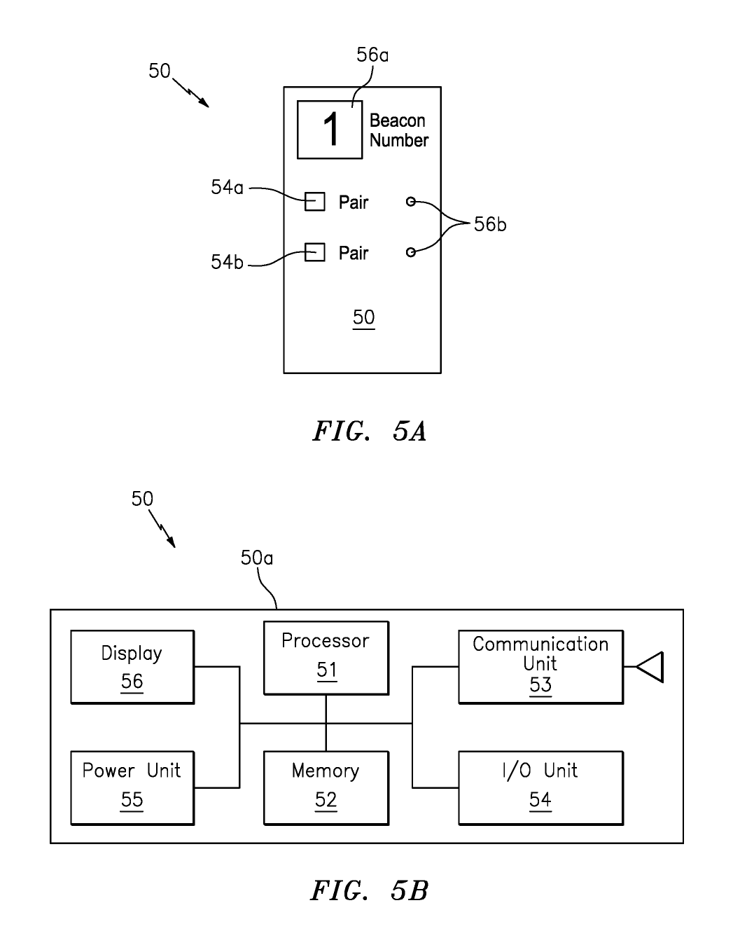

FIGS. 5A and 5B illustrate one embodiment of a target beacon 50. Although only one beacon is shown, the system can utilize any number of different beacons which can each be secured to, or worn by the person or object being filmed. As shown, each of the target beacons 50 can include a main body 50a for housing a processor 51 that is conventionally connected to an internal memory 52, a beacon communication unit 53, an input/output unit 54, a power source 55 and/or a visual display unit 56.

The body 50a can take any number of distinct shapes, and can be constructed from any number of known materials and methods. In one preferred embodiment, body 50a can be constructed from a thin and lightweight mold of injection molded plastic having a shape and size that is as small as possible. As described herein, the processor 51, memory 52, beacon communication unit 53 and power source 55 can be substantially identical to the above described processor 41, memory 42, communication unit 43 and power source 45, therefore the description of these elements will not be repeated.

The input/output unit 54 can include any number of different components such as the illustrated resilient push buttons 54a and 54b, for example, which can act to accept user inputs and provide instructions to the processor 51. In one preferred embodiment, each of the buttons can be connected to the processor 51 so as to activate different programmatic functions. For example, one such button can initiate programming for instructing the communication unit 53 to establish wireless communication with the communication unit 43 of the camera unit 30. In another example, one of the buttons can function to switch the beacon between an ON and OFF operating state and/or initiate a sleep mode, for example. Of course, the device is not limited to the use of push buttons, as any device capable of receiving user instructions is also contemplated.

The visual display unit 56, can include any number of different elements capable of presenting information to a device user, such as the illustrated display screen 56a and/or LED's 56b. Several nonlimiting examples include LCD displays, LED lights and displays, electro-luminescent displays and the like. In this regard, the display unit can function to provide information to a device user such as, for example, the power state (on/off) of the beacon, whether the beacon is paired with the camera unit, and/or the target beacon identification number assigned by the camera unit.

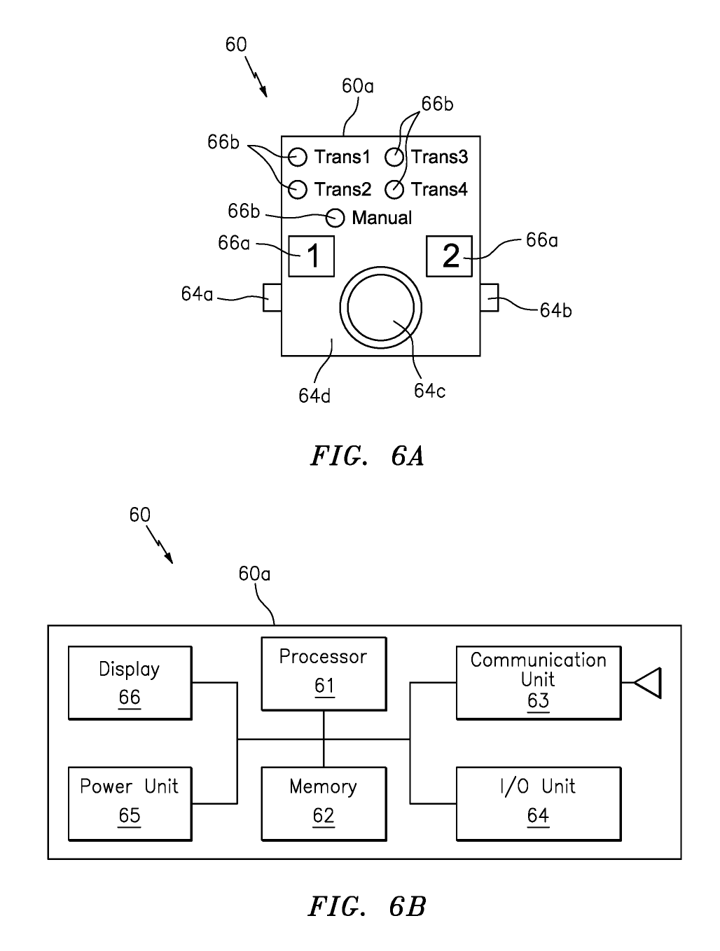

FIGS. 6A and 6B illustrate one embodiment of the remote operation unit 60. As shown, the unit 60 can also include a main body 60a for housing a processor 61 that is conventionally connected to an internal memory 62, a remote communication unit 63, an input/output unit 64, a power source 65 and/or a visual display unit 66.

In one embodiment, the body 60a can also be constructed from injection molded plastic, having any number of different shapes and sizes. As described herein, the processor 61, memory 62, communication unit 63, power source 65 and display unit 66 can be substantially identical to the above described processor 41, memory 42, communication unit 43, power source 45, and display unit 56, therefore the description of these elements will not be repeated.

The input/output unit 64 can include any number of different components such as the illustrated resilient push buttons 64a, 64b and 64c, for example, which can act to accept user inputs and provide instructions to the processor 61. In one preferred embodiment, the input/output unit can also include a rotatable knob 64c which can allow a user to remotely operate the motor 32 of the of the camera unit 30, in order to adjust the camera focus via the circular drive gear 33.

In various embodiments, the input/output unit can receive user instructions to perform tasks such as switching which target beacon 50 is being actively tracked (i.e., an active target beacon), by the camera unit 30, establishing lag times when switching between beacons, and/or establishing preferred focus settings based upon the distance each beacon is from the camera unit.

In operation, the camera unit 30 can be coupled with a camera 1 and/or rail system 2. Once so positioned, a user can utilize the remote operation unit to instruct the motor 32 to rotate the gear 33, thereby adjusting the focus 1a of the camera 1, as described above.

Next, a user can select one or more target beacons 50 to be tracked by the camera unit. In this regard, each beacon can be wirelessly paired with the camera unit, so as to send and/or receive information therefrom. Each of the beacons can be manufactured so as to automatically pair with a particular beacon at a time of manufacture, and/or can include functionality for being paired with a camera unit by a user.

Once paired, the camera unit can continuously monitor the separation distance (i.e., how far the beacon is from the unit 30), at all times. In one embodiment, the separation distance can be determined by measuring the response time of signals sent from the camera unit 30 to a particular target beacon 60. For example, the camera unit 30 can be programmed to automatically transmit a connection signal to an active target beacon at specified intervals. Upon receiving the connection signal, the beacon can be programmed to immediately send a response signal. An algorithm can be stored within the camera unit memory that can determine exact distances based upon the response time. As such, the separation distance can be displayed to a device operation via one or both of the display units 35, 56 and 66.

Of course, the inventive concepts described herein are not limited to the above described method for determining a separation distance. To this end, any number of other methods and/or components that are capable of determining a separation distance between the camera unit and each target beacon can be provided by or within the system without undue experimentation.

Once a beacon 50 and the camera unit 30 are active, a user must initially program the system for each particular shoot. In one embodiment, the system can be programmed when a device user activates a “learn button,” such as button 64d, for example, and then manually adjusts the knob 64c while the target beacon moves toward or away from the camera unit. During this operation, the device operator will maintain the target in the desired focus, and such settings can be saved by the memory of the camera unit and/or remote operation unit.

Once the system has been programmed, the user can instruct the remote operation unit to automatically operate the camera unit based on the distance between the camera unit and the active target beacon. Additionally, the device operator can utilize the buttons of the remote operation unit 60 to switch between active beacons, wherein switching from one beacon to another will cause the camera unit change the focus settings to match the separation distance with the selected beacon.

Accordingly, the above described automatic follow focus system 100 functions to automatically adjust the focus of any camera based on the distance with the camera target in a novel manner.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An automatic follow focus system for attachment onto a camera having a focusing control and a rail system, said follow focus system comprising:
a camera unit that includes:
a device controller having a first communication unit,
a main body for housing the device controller,
an electric motor that is coupled to the main body and is in communication with the device controller,
a circular drive gear that is coupled to the electric motor, and
a rail mounting unit that extends from the main body and functions to removably engage the rail system;
one or more target beacons, each of said beacons including a beacon communication unit for communicating wirelessly with the camera unit; and
a remote operation unit that includes:
an input/output unit for receiving operating instructions, and
a remote communication unit for communicating wirelessly with the camera unit.

2. The system of claim 1, wherein the device controller of the camera unit includes functionality for determining a separation distance between the camera unit and each of the one or more target beacons.

3. The system of claim 2, wherein the remote operation unit includes functionality for designating one of the one or more target beacons as an active target beacon.

4. The system of claim 3, wherein the remote operation unit further comprises:
a display that is configured to show the separation distance between the camera unit and each of the one or more target beacons.

5. The system of claim 3, wherein the remote operation unit includes functionality for selectively operating the motor of the camera unit based upon the determined separation distance between the camera unit and the active target beacon.

6. The system of claim 5, wherein the circular drive gear rotates when the motor of the camera unit is in operation.

7. The system of claim 6, wherein the circular drive gear includes a shape and size that is configured to engage at least one of a focusing ring and a focus control of a camera lens.

8. The system of claim 5, wherein the one or more target beacons comprises:
a plurality of target beacons.

9. The system of claim 8, wherein the remote operation unit includes functionality for changing which of the plurality of target beacons is the active target beacon.

10. The system of claim 8, wherein the remote operation unit further comprises:
a display that is configured to show which of the plurality of target beacons is the active target beacon.

11. The system of claim 1, wherein the camera unit further comprises:
a camera display that is secured along an outside portion of the main body.

12. The system of claim 11, wherein the camera unit includes functionality for displaying an operating status of each of the one or more target beacons.

13. The system of claim 12, wherein the camera display includes a Graphic user interface.

14. The system of claim 1, wherein the device controller of the camera unit includes functionality for determining a separation distance between the camera unit and each of the one or more target beacons; and
each of the one or more target beacons includes a visual display unit.

15. The system of claim 14, wherein the device controller of the camera unit is configured to instruct each of the one or more target beacons to display the separation distance between the target beacon and the camera unit.
